(19) United States
(12) Patent Application Publication
(10) Pub. No.: US 2026/0117331 A1
(43) Pub. Date: Apr. 30, 2026

(54) MANAGEMENT OF OFFGAS DUCT ACCRETIONS IN A SMELTING PROCESS

(71) Applicant: Nucor Corporation, Charlotte, NC (US)

(72) Inventors: Rodney James Dry, City Beach (AU); Mark Hayton, Perth (AU); Christopher Manning, North Easton, MA (US)

(73) Assignee: Nucor Corporation, Charlotte, NC (US)

(21) Appl. No.: 19/370,034

(22) Filed: Oct. 27, 2025

Related U.S. Application Data
(60) Provisional application No. 63/712,844, filed on Oct. 28, 2024.

(51) Int. Cl. C21B 13/00; A46B 5/06; A46B 13/00; A46B 13/02; A46D 1/00; F23J 3/02; F27D 17/30

(52) U.S. Cl. CPC C21B 13/0013; A46B 5/06; A46B 13/001; A46B 13/02; A46D 1/0207; F23J 3/026; F27D 17/30; A46B 2200/3013; C21B 2100/00; C21B 2300/02

(57) ABSTRACT

The present disclosure is directed to an improved direct smelting process for improving the efficiency of energy/heat recovery from hot smelter offgas for the purpose of steam raising and power generation. In examples, the formation of alkali sulfate accretions in the temperature range 500-1000° C. are removed by introducing a mechanical sweep-cleaning system to an offgas duct of the smelter. The sweep-cleaning system comprises at least one central rotating shaft with chains, with each chain optionally having an accretion-removal member at its distal end. When rotated, the chains lift and the accretion-removal member sweeps the walls of the duct to remove the accretions.

### CROSS REFERENCE TO RELATED APPLICATIONS

This application claims the benefit of U.S. Provisional Application No. 63/712,844 filed on Oct. 28, 2024, the entirety of which is incorporated herein by reference.

### TECHNICAL FIELD

The present disclosure relates to an improved process and an improved apparatus for direct smelting a metalliferous material.

### BACKGROUND

Two direct smelting processes for a metalliferous material which rely principally on a molten bath as the smelting medium are generally referred to as the HIsmelt process and the HIsarna process. The HIsmelt process utilizes a smelt reduction vessel (“SRV”), while the HIsarna process utilizes an SRV in conjunction with a cyclone converter furnace (“CCF”).

The HIsmelt process relates to direct smelting of metalliferous material in the form of iron and its oxides (which may be unreduced, partly reduced or highly pre-reduced) and producing molten carbon-containing iron. The process includes forming a bath of molten iron and slag in a vessel (SRV). Solid carbonaceous material (e.g., coal, or the like) is injected into the bath. Metalliferous material may be injected into the bath and/or fed into the slag layer by dropping from above. Solid carbonaceous material acts as a reductant of the iron oxides and a source of energy for forming the molten metal bath within the SRV.

The HIsmelt process also includes post-combusting reaction gases, such as CO and H2 released from the bath, in the generally gas-continuous space above the bath e.g., referred to as the topspace, with oxygen-containing gas, typically hot oxygen-enriched air or technically pure cold oxygen. Heat generated by post-combustion reactions is transferred to the bath to satisfy the thermal energy required to heat and smelt the metalliferous materials.

The HIsmelt process also includes forming a transition zone above the nominal quiescent surface of the bath. In this zone, there is a mass of ascending and descending droplets and splashes or streams of molten metal and/or slag, which provides an effective medium to transfer to the bath a significant portion of the thermal energy generated by post-combusting reaction gases above the bath. In examples, this plume moves heat from the topspace where it is generated at relatively high oxygen potential to the bath where it is used for smelting purposes at relatively low oxygen potential. As such, in examples, the plume effectively acts as a heat pump.

In the HIsmelt process, solid carbonaceous material and optionally metalliferous material are injected into the molten bath through a number of solids injection lances. These lances may be inclined to the vertical so as to extend downwardly and inwardly through a side wall of the vessel and into a lower region so as to deliver at least part of the solids material into a molten metal layer in the bottom of the vessel. To promote the post-combustion of reaction gases in an upper part of the vessel, cold oxygen, or a blast of hot air, which may be oxygen-enriched, is injected into an upper region of the vessel through one or more downwardly extending gas injection lances. Offgas resulting from post-combustion of reaction gases in the vessel are taken away from the upper region of the vessel through an offgas duct. The vessel also includes slag-coated water-cooled panels in the side walls and the roof of the vessel, through which water is circulated in a closed cooling circuit.

Molten metal product is removed from the smelt reduction vessel (SRV) via a forehearth. The forehearth is a siphon overflow device connected to the bath via an opening (“forehearth connection”) near the bottom of the metal bath in the SRV. The forehearth allows for extraction of molten metal from the SRV in a continuous manner during operation, while maintaining a metal level in the SRV that allows safe operation e.g., keeping bulk metal well away from water-cooled elements.

The HIsarna process, as far as the SRV is concerned, has the same or similar physical components and layout as the HIsmelt process, and operates in the same or similar way. One difference between the two is that in the HIsarna process incoming metalliferous feed (typically iron ore) is not injected or dropped directly into the bath but is rather heated, partially pre-reduced, and substantially melted in a smelt cyclone (CCF) which is directly coupled to the top gas outlet of the SRV. Substantially molten, partly reduced iron ore droplets fall from the smelt cyclone into the SRV slag, and from there final smelting proceeds. Principally, carbon-rich metal reacts with FeO in slag to produce additional carbon-containing iron metal. Carbonaceous material is still injected into the bath as previously described to carburize metal and generate the splash, fountain plume, and mixing within the SRV.

In both the HIsmelt and HIsarna processes, hot offgas, either from the SRV directly or from the CCF, is removed from the process via a steam-cooled (or water-cooled) offgas duct. In the case of HIsarna, additional oxygen may be injected into this duct in order to complete combustion of residual fuel gas, mainly CO and H₂.

In examples, the first part of this hot offgas duct, commonly referred to as the “dogleg”, is such that up-flowing hot gas from the SRV or CCF is forced to change flow direction twice, (i) vertical to near-horizontal and (ii) near-horizontal back to vertical. In this duct configuration, solid slag adhesion onto the walls is actively encouraged via mechanical means such as placement of slag adhesion studs or similar devices configured to encourage formation of a frozen slag layer on the duct wall adjacent to saturated steam/water or cooling water-containing tubes that typically jacket its outer wall. This frozen layer will grow or re-grow on cooled tube surfaces to a “natural” thickness of typically 20-30 mm. At this point further solid layer growth slows because cooling by conduction through 20-30 mm of frozen slag is more or less balanced by heat supplied from hot process offgas. A small semi-solid layer will then form, and on top of that layer, slag will remain molten. In this context the actual liquid is referred to as “molten slag”, even though it may in some cases comprise predominantly melted and partly reduced iron ore.

The dogleg of the HIsmelt and HIsarna systems are designed to maintain molten slag inner surfaces. Liquids carried in the main offgas stream can be de-entrained by being thrown onto the walls by virtue of residual swirl and flow direction changes as described earlier. This de-entrained liquid slag can then run back into the SRV under gravity, countercurrent to outgoing hot offgas. Gas velocity in the dogleg is insufficient (by design) to force liquid slag in the wall layer to flow in the same direction as the gas. Instead, liquid is able to run back under gravity towards and into the SRV, countercurrent to the gas flow direction. This concept has been tested extensively and shown to work reliably.

In the HIsmelt and HIsarna plant designs, hot gas leaving the dogleg enters a further cooling duct in the shape of a large inverted “U”, commonly referred to as the “hood”. This comprises an upflow duct (or upleg), a large 180-degree bend at the top (usually with one or more pressure relief valves) and a “downflow duct” or “downleg”. Duct walls are again (typically) constructed from steam-tubes, but in this part of the system walls are internally smooth with no slag adhesion studs or similar devices. Solid slag is not encouraged to adhere to the walls of the hood. The process objective is to cool hot process gas in the upleg to a temperature below that at which any liquid materials can still be present (typically 900-1000° C.). In examples of this design, sheets of slag solidify on smooth inner steam tube wall surfaces and grow in size until they become (naturally) unstable and fall off. Fallen solid sheets then enter the top of the dogleg where they are heated and melted (over time), then run back into the SRV as liquid. In another version of this design, cold (recycle) gas is added in an annular ring at the base of the upleg to cool gas and solids more rapidly, while at the same time keeping molten droplets away from the walls of the upleg.

In the HIsmelt and HIsarna plant designs, offgas from the hood downleg is de-dusted, for example, using conventional dust cyclones, and finally heat from the offgas is recovered, for example, by presenting to a steam boiler.

While molten slag accretions are adequately managed via the HIsmelt and HIsarna plant designs, unfortunately, there is a second lower temperature accretion formation mechanism in the downflow duct that results in tenacious or sticky phases comprising alkali sulphates or similar materials can form (slowly) at temperatures above about 500° C. These sticky materials act as a type of glue phase, and solid particles which happen to be present as dust etc. can become nucleators for low-temperature accretions with solid dust particles acting like aggregate particles in cement. This type of low-temperature accretion builds and densifies over time, to the extent that, for example, heat transfer in the downflow duct of the hood becomes greatly attenuated. This type of accretion growth is thought to be largely one-directional, meaning (for example) downflow duct walls become progressively fouled over time with no “natural” self-cleaning mechanism.

These low-temperature accretions also tend to build up especially on superheater tubes in a steam boiler that receives the offgas, which can significantly compromise boiler performance over time. Superheater tubes have the highest metal wall temperatures in the heat recovery system, typically around 400-550° C., and this makes them significantly more susceptible to this low-temperature accretion type of fouling, resulting in compromised steam boiler availability. If only one such boiler is present, the availability of the entire ironmaking plant may be compromised. While it is possible to utilize two such boiler systems and alternate between them, this is considered an undesired, overly expensive, and labor-intensive solution.

### SUMMARY

In examples, a sweep-cleaning system for a smelt reduction vessel offgas hood is provided, the sweep-cleaning system comprising a centrally rotating vertical shaft configured for positioning within a downflow duct of the offgas hood; a plurality of chains proximally coupled to the centrally rotating vertical shaft and extending distally from; an accretion-removal member coupled to a distal end of the plurality of chains; and at least one drive motor configured to rotate the centrally rotating vertical shaft at a rotational speed, causing the plurality of chains to rise vertically proportional to the rotation speed within the at least one downflow duct. In examples, the sweep-cleaning system comprises an additional centrally rotating vertical shaft driven by the same or another drive motor. In aspects, the rotational speed is variable, constant, or programmed. In aspects, the accretion-removal member is configured to either contact wall and offgas accretions present on an interior surface of the downflow duct when rotating, or deliberately sweep close to the wall without touching it. In aspects, the smelt reduction vessel is coupled to cyclone converter furnace (CCF).

In other examples, an offgas system hood configured for operably coupling with a smelt reduction vessel (SRV) is provided, the offgas system comprising at least one downflow duct having a interior surface; at least one centrally rotating shaft positioned within the at least one downflow duct; and at least one chain connected along the centrally rotating shaft and distally extend therefrom, wherein rotation of the at least one centrally rotating shaft causes the chain to rise vertically proportional to a rotation speed within the at least one downflow duct. In aspects, the smelt reduction vessel is coupled to cyclone converter furnace (CCF).

In other examples, a method of management of offgas accretions in a smelting reducing vessel coupled to a hood, the method comprising: providing at least one downflow duct operably coupled to the hood, the at least one downflow duct comprising: an interior surface; at least one centrally rotating shaft positioned within the at least one downflow duct; and at least one chain proximally connected along the centrally rotating shaft and distally extend therefrom; and an accretion-removal member connected to a distal end of the at least one chain. The method comprises rotating the at least one centrally rotating shaft at a rotation speed and causing the chain to rise vertically proportional to the rotation speed within the at least one downflow duct; and removing at least some offgas accretions from the downflow duct.

In yet other examples, a direct smelting process is provided, the process comprising: a smelt reduction vessel (SRV) configured for containing a bath of molten metal and slag; an offgas system comprising at least one downflow duct, the at least one downflow ducts are each equipped with at least one centrally rotating shaft and a series of connected chains extending distally therefrom configured to rotate within an interior surface of the downflow ducts; injecting carbonaceous material and final smelting of metalliferous ore into the SRV. The method comprises producing carbon-containing hot metal, molten slag, and CO-containing offgas, injecting oxygen-containing gas into a topspace above the molten slag; at least partially combusting the CO-containing offgas; removing at least some accretions from the walls of the at least one downflow duct with the series of connected chains connected to the at least one rotating shaft positioned in the downflow duct; and providing enhancement of wall heat transfer and SRV process heat. In aspects, the smelt reduction vessel is coupled to cyclone converter furnace (CCF).

### BRIEF DESCRIPTION OF THE DRAWINGS

The present disclosure is described further by way of examples with reference to the accompanying drawings, of which:

FIG. 1 is a view of an exemplary direct smelting process involving an SRV, a CCF, an offgas hood and a sweep-cleaning accretion removal system in the downflow duct of the offgas hood according to the present disclosure.

FIG. 2 is an enlarged view of section 2 of FIG. 1 of the sweep-cleaning accretion removal system.

FIG. 3 is a view of an exemplary direct smelting process involving an SRV, a CCF, a double-downflow duct offgas hood with sweep-cleaning removal systems according to the present disclosure.

FIG. 4 is a view of an exemplary direct smelting process involving an SRV, a CCF, a downflow duct offgas hood with a sweep-cleaning accretion removal system and an integrated boiler into the hood according to the present disclosure.

### DETAILED DESCRIPTION

The present disclosure is directed to an improved direct smelting process and a sweep-cleaning system for a smelt reduction vessel offgas hood. In particular, the present disclosure is directed to improving the efficiency of energy recovery from hot smelter offgas for the purpose of steam raising and power generation by management of the offgas accretions. Hot offgas from a smelter reactor vessel (“SRV”) and, if present, a CCF contains molten particles together with small amounts of alkali metals (such as sodium, potassium and calcium) and sulfur-containing gas species such as H2S and/or SO2. The molten droplets can be dealt with by cooling and freezing, either onto the walls of a steam-cooled hood with a duct (with subsequent freeze layer detachment) or by cold recycle gas injection to quench-cool molten droplets. Freezing is more or less complete by the time the offgas is cooled to about 1000° C. Below this temperature there is a second accretion formation mechanism involving (sticky) alkali sulfate formation. There is no natural removal mechanism for the alkali sulfate formation, making energy recovery problematic. Such accretions are initially weak and powdery, but over time the alkali sulfate formation tends to sinter into more solid layers.

The present disclosure addresses this by introducing a mechanical sweep-cleaning system based on rotating one or more chains and one or more accretion-removal members. At least one central rotating shaft is used in a downflowing duct whose walls comprise steam tubes. In the absence of such a system this duct would normally foul over time with accretions of the type described above. With the presently disclosed shaft sweep system, chains are connected to the shaft and each chain has an accretion-removal member. In examples, the accretion-removal member is the most one or two distal links of the chain, which may be of the same or different metal composition as the remainder of the chain. In examples, the accretion-removal member is a wire brush at the distal end of the chain. In examples, the accretion-removal member is a brush with bristles.

When rotated at a certain speed, chains and accretion-removal member almost touches the inner duct wall. This leads to increased local velocities and improved heat transfer to the wall, together with potential for wind-blown removal of lightly bonded accretions. If necessary, rotation speed can be increased further such that accretion-removal member lift incrementally and just touches the wall. Lightly bonded accretions may then be physically swept off. This allows sustained, reliable energy recovery from hot smelter offgas.

In examples, the present disclosure is configured for use with a HIsarna process. In other examples, the present disclosure is configured for use with HIsmelt process.

Examples of the present disclosure comprise the features hereinafter fully described and particularly pointed out in the claims. The following description and the annexed drawings set forth certain illustrative features of the one or more examples. These features are indicative, however, of but a few of the various ways in which the principles of various examples may be employed, and this description is intended to include all such embodiments and their equivalents.

Examples of the present disclosure will now be described more fully hereinafter with reference to the accompanying drawings, in which some, but not all, examples of the present disclosure are shown. Indeed, the present disclosure may be embodied in many different forms and should not be construed as limited to the examples set forth herein.

The term “smelting” is herein understood to encompass thermo-chemical processing where chemical reactions that reduce metal oxides occur and produce carbon-containing molten metal. Smelting takes place (i) at high temperatures, (ii) only at sufficiently low oxygen potential and (iii) is highly endothermic, requiring a large heat supply to maintain constant process conditions.

The term “accretion” is herein understood to encompass a growth or increase, typically by a gradual accumulation of layers or matter and includes, without limitation, high and low temperature growth of material occurring in hoods and/or ducts of a SRV.

Thus, in examples, the present disclosure seeks a technical solution to the technical problem of buildup of low-temperature accretion in the downleg of a hood coupled to an SRV, optionally with a CCF. Given that the hood upleg begins at the elevation of the dogleg, which is above the SRV and CCF, there is potential for deployment of a long downleg, for example, 60-70 m. Other lengths may be used. In its normal state this downleg will accumulate low temperature accretions and outlet temperature will increase gradually over time. By way of example, the offgas hood on a commercial-scale HIsmelt plant in Kwinana, Western Australia initially operated at an outlet temperature around 500° C. when clean. Over time this increased to about 1000° C. as low temperature accretions built up. Ultimately, very little heat was available from the downleg because the heat transfer driving force was low and these accretions are a barrier to heat transfer.

The present disclosure provides for addressing offgas hood downleg temperature so that they can be maintained in the range 400-500° C., e.g., with energy reporting to a steam drum at the top of the hood, and manageable and sustainable overall heat recovery becomes possible. In examples, an external natural gas fired (clean) superheater can be used in conjunction with an optional boiler and economizer tubes in the dirty gas stream downstream of the hood. In examples, cooling the process gas below 400-500° C. in the hood downleg provides for minimizing further accretion formation and more efficient energy recovery possible. In examples, hood outlet temperatures are kept below about 500° C. despite the growth of low-temperature accretions.

In examples of the proposed improved system, at least one rotating shaft is installed down the center of the downleg. Proximally attached to each of the at least one rotating shaft are metal chains. Each chain terminates distally from the shaft to the accretion-removal member. The aim is to operate the system by rotating the central shaft at a one speed most of the time then, for example, once a shift for a period of perhaps half an hour, increasing shaft rotation speed to a higher level.

At the lower rotation speed brush tips are just short of touching the walls—this is referred to as “contactless mode”. Rotating accretion-removal members cause significantly increased wall boundary layer gas turbulence and higher heat transfer rates, while also enhancing radial mixing generally and forcing the bulk fluid mechanics profile closer to that of ideal plug flow. Under such conditions accretions can be at least partially swept off by virtue of higher local gas velocities and the presence of fine iron ore dust in the gas, which can act as a gentle scouring agent.

At the higher rotation speed the chain tip accretion-removal members rise incrementally, such that in examples, they just touch the walls and actively sweep the internal surface of the hood downleg. This is termed “contact mode” and can be used to remove low-temperature accretions which have formed but not yet densified and hardened but are not amenable to removal in the slower-speed, more gentle contactless mode.

Such a device will naturally wear over time, for example, an accretion-removal member comprising a distal chain link or a brush with bristles on each brush becoming shorter as they are worn down in contact mode. Distal chain link material and brush strand thickness and material type needs to be calibrated to minimize tube wall damage while maximizing accretion removal performance. This invariably means the accretion-removal member will become shorter the longer they are in service. The design of the cleaning system will take this into account (at least partially) by allowing for slight further increases in rotation speed when the accretion-removal members are worn. In examples, with accretion-removal members just touching the walls, the angle between the rotating chains and the vertical could increase from about 80 degrees initially to about 85 degrees with fully worn accretion-removal members. This will allow at least partial extended accretion-removal member campaign life. Natural elongation (creep) of chain links may also play a beneficial role in terms of extending the “reach” of worn accretion-removal members. However, offline accretion-removal member replacement will become necessary once cleaning efficiency drops (despite maximum shaft rotation speed being applied).

Process feedback regarding the effectiveness of contact mode wall cleaning could be almost instantaneous. Steam production in the hood steam drum will increase and downleg outlet temperature will decrease in direct response to wall accretion removal. Additionally, drive motor torque could provide a degree of feedback in terms of how hard accretion-removal members are pushing against the tube walls.

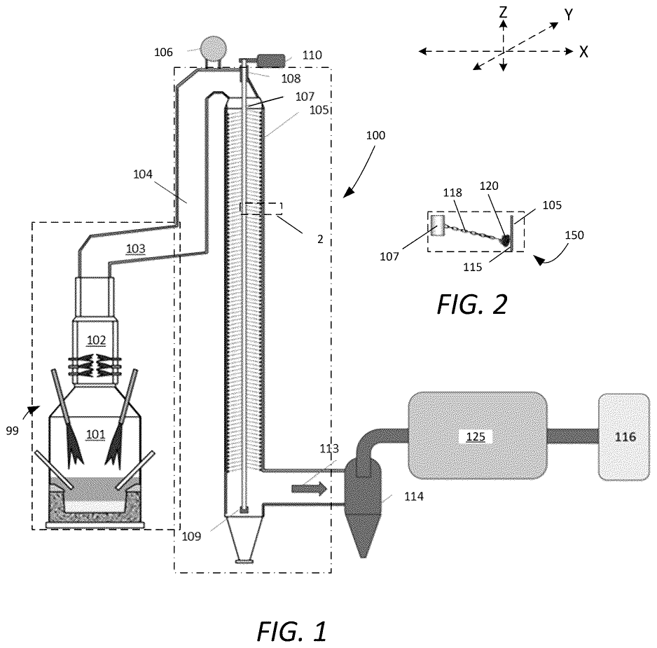

FIG. 1 illustrates a direct smelting process 99 comprising SRV 101, CCF 102 and a dogleg 103 operably coupled thereto. Hood 100 comprises upleg 104 and downflow duct 105. In examples, the hood wall is constructed from steam tubes, optionally with webbing spacers between individual tubes. Heat extracted from process offgas generates saturated steam in steam drum 106. Process gas pressure in the hood is typically 0.5-0.8 bar gauge and saturated steam pressure is typically 40-80 bar gauge.

Shaft 107 is inserted into the hood 100 downflow duct 105 with water-cooled top pressure bearing seal 108 and 109 bottom pressure bearing seal. Bearing seals 108, 109 allow shaft rotation while maintaining a pressure seal. Additional guide bearings (not shown) may be used at intermediate locations. At least one drive motor 110 is operably connected to the shaft 107 and provides for controllable rotation speed within a preset range or a programmed range. In examples, shaft 107 is cooled, either by cooling water or by steam-raising (not shown). In examples, steam drum 106 makeup water is used as shaft coolant in the liquid phase before it enters the steam drum.

In examples, shaft 107 has a plurality of chains 111 proximally connected thereto and distally extending therefrom. In examples, at least one chain has a accretion-removal member 120 connected to its loose end. In examples, each accretion-removal member 120 is a chain link or is a wire brush connected to its loose, distal end. Accretion-removal member 120 is configured to withstand high temperatures. In examples, chain link or wire brush accretion-removal member is of an alloy steel construction appropriate for temperatures up to about 1000° C.

FIG. 2 depicts an enlarged view of section 2 of FIG. 1 showing sweep-cleaning system 150 comprising shaft 107, chain 118, and accretion-removal member 120, exemplified as a wire brush, configured to interact in contact mode or non-contact mode with internal side wall 115 of downflow duct 105 for removal or reducing accretions.

In examples, sweep-cleaning system 150 is operated in contactless mode most of the time, such that accretion-removal member 120 hang downwards at a non-perpendicular angle relative to shaft 107 slightly and avoid contact with interior wall 115 of hood 100. In examples, the accretion-removal members form an angle of less than or equal to 80 degrees during shaft 107 rotation. In examples, the angle of the chain 118/accretion-removal member 120 with shaft 107 varies with shaft rotation speed. This configuration of sweep-cleaning system 150, compared to a system without a sweep-cleaning system, includes the following improvements:
enhanced wall heat transfer;
increased uniformity of gas flow as a result of enhanced radial gas mixing; and
at least partial accretion removal due to high local gas velocities and mild scouring from fine iron ore particles.

In examples, after a given time interval, which may be determined by how dirty the wall has become based on steam drum flow and downleg outlet temperature, shaft 107 is rotated at a higher speed for a short period in contact mode, such as, for example, 30 minutes. At this higher rotation speed the accretion-removal member tips sweep the inner hood walls to remove low-temperature accretions which, at this point, are still “fluffy” and easy to remove. Steam drum flow and hood outlet temperature will show, in examples, almost instantly, how effective this mechanical cleaning action is and when rotation speed can be safely reduced to its lower contactless-mode level.

In examples, accretion-removal member 120 comprises a brush with a plurality of strands (not shown). In examples, brush strand thickness is calibrated to provide adequate accretion removal while avoiding long-term damage to interior wall 115 of hood 100. In examples, brush strand material is softer than typical boiler tube steel making up interior wall 115 of hood 100, so as to avoid any danger of melting and providing suitable chemical stability. On the tube wall side, selective hard facing may be applied in regions most prone to brush-related tube wear.

Tips of the brush strands will wear away during normal service. If this proceeds too far, brushes will no longer be able to reach the hood wall and cleaning system 150 decrease in effectiveness. In examples, to counteract this, at least for a time interval, initial brush strand length will be longer than needed and rotation speed during contact mode will be slower. In examples, in contact mode, chains will extend slightly downwardly from the rotating shaft, with about an 80 degree angle between them and the shaft's longitudinal axis. Torque on the drive motor can be used to provide an appropriate distance from accretion-removal member 120 and interior wall 115 of downflow duct 105. In examples, as accretion-removal members 120 wear, contact mode rotation speed may be increased such that motor torque and cleaning efficiency are maintained. In examples, the chain-to-shaft angle may approach 90-degrees and further increases in rotation speed will reduce effectiveness of cleaning system 150. In examples, the accretion-removal members can be replaced offline. In examples, in a design phase, ease-of-replacement options for fast turnaround is considered, as well as recovery from excessive slag foaming events that could occur in this type of system.

In examples, control of offgas 113 temperature to less than about 500° C. is used, In other examples, a lower temperature, e.g., 400° C., may also be used since accretion growth downstream will decline rapidly as temperature drops below 500° C. Cooled offgas 113 passes to dry dust separator/collection system 114 which may comprise a set of cyclones. In examples, partially de-dusted offgas is introduced to boiler 125 containing boiler and economizer tubes. In examples, partially de-dusted offgas is introduced to boiler 125 containing boiler and economizer tubes without superheater tubes. In examples, process gas is cooled to about 200-250° C. in boiler 125 before passing to a final dust removal stage 116 which may comprise a wet scrubber or a pressurized baghouse.

Saturated steam generated in steam drum 106 and boiler 125 is superheated and introduced to a separate clean-gas device such as a natural gas fired furnace (not shown). In examples, superheated steam is converted into electric power. The contribution of steam from steam drum 106 and boiler 125 is such that, if electrical power generation efficiency is calculated from energy contained in natural gas, e.g., used for the superheater furnace alone, efficiency exceeds 100%. Thus, in examples, the use of natural gas superheating in conjunction with a sweep-cleaning system as presently described provides a solution which is both practical and efficient.

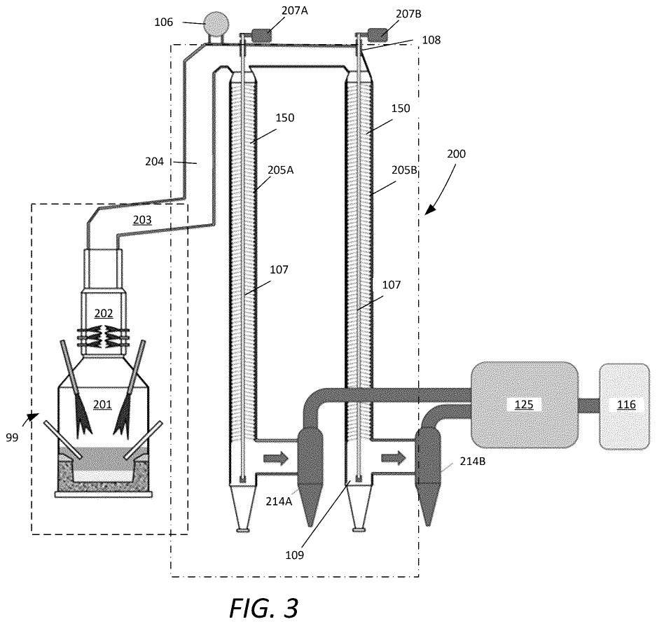

FIG. 3 shows an alternate example of direct smelting process 99 comprising SRV 201, CCF 202, dogleg 203 and hood 200 comprising upleg 204 and two separated downlegs 205A and 205B, each shown with its own dedicated sweep-cleaning system 150. In examples one of legs 205A comprises sweep-cleaning system. In examples, each of downlegs 205A and 205B has its own drive motor 207A, 207B, and its own primary dust separator/collection 214A and 214B, for example, cyclone systems, respectively. In examples, offgas from both legs enter a common boiler 125 for further heat recovery.

A technical problem with split systems includes flow imbalance between the two branches. However, in examples presently disclosed, each downleg 205A and 205B has a dust separator/collection device 214A and 214B such as a cyclone or group of cyclones at its outlet. This provides sufficient pressure drop to keep flows properly balanced.

This present arrangement of hood 200 provides for around 40% greater cooling surface in the downlegs 205A and 205B compared to a single-downleg example as a solution to this technical problem. For example, if the temperature of gas leaving a single hood downleg(s) is still high enough to allow accretions to form on boiler tubes, plant availability of this residual heat could be compromised. The double-downleg arrangement of hood 200 therefore provides a greater degree of certainty that adequate cooling is accomplished in return for higher hood installation cost.

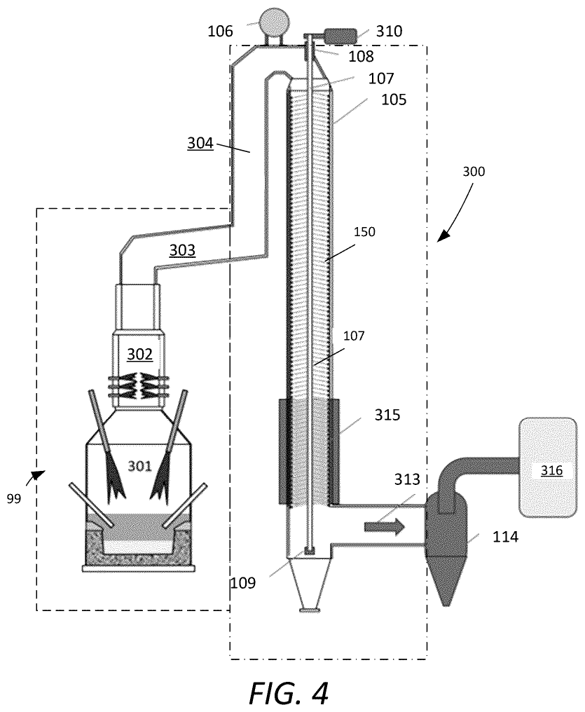

FIG. 4 shows an alternate example of direct smelting process 99 comprising SRV 301, CCF 302, and hood 300 comprising dogleg 303 and hood upleg 304 that are essentially as described in FIG. 1. Downflow duct 305 of hood 300 is equipped with a sweep-cleaning system 150, but in this example, the bottom section of downleg 305 is cooled by integrated boiler 125 feed water jacket 315 arranged near bottom of downflow duct 305 in the liquid phase throughout, thus performing the function of an integrated economizer.

With accretion-removal member induced wall heat transfer enhancement, in examples, using the present sweep-cleaning system 150, process gas 313 is cooled below temperatures which would otherwise be possible. In examples, total integration of the boiler into the hood, obviating the need for any type of downstream tube system in contact with dirty process offgas, is provided.

Specific embodiments of the present disclosure are described herein. Many modifications and other embodiments of the present disclosure set forth herein will come to mind to one skilled in the art to which the present disclosure pertains, having the benefit of the teachings presented in the foregoing descriptions and the associated drawings. Therefore, it is to be understood that the present disclosure is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

We claim:

1. A sweep-cleaning system for a smelt reduction vessel offgas hood, the sweep-cleaning system comprising:
at least one centrally rotating vertical shaft configured for positioning within a downflow duct of the offgas hood;
a plurality of chains proximally coupled to each of the at least one centrally rotating vertical shaft and extending distally therefrom;
an accretion-removal member coupled to a distal end of the plurality of chains; and
at least one drive motor configured to rotate the centrally rotating vertical shaft at a rotational speed, causing the plurality of chains to rise vertically proportional to the rotation speed within the at least one downflow duct.

2. The sweep-cleaning system of claim 1, wherein the smelt reduction vessel is coupled to cyclone converter furnace (CCF).

3. The sweep-cleaning system of claim 1, wherein the rotational speed is variable, constant, or programmed.

4. The sweep-cleaning system of claim 1, wherein the accretion-removal member is one or more distal chain links of each of the plurality of chains.

5. The sweep-cleaning system of claim 1, wherein the accretion-removal member is a brush comprising metal bristles.

6. The sweep-cleaning system of claim 1, wherein the accretion-removal member is configured to contact offgas accretions present on an interior surface of the downflow duct when the centrally rotating vertical shaft is rotating.

7. An offgas system hood configured for operably coupling with a smelt reduction vessel (SRV), the offgas system comprising
at least one downflow duct having a interior surface;
at least one centrally rotating shaft positioned within the at least one downflow duct; and
at least one chain connected along each of the at least one centrally rotating shaft and distally extend therefrom, wherein rotation of the centrally rotating shaft causes the chain to rise vertically proportional to a rotation speed within the at least one downflow duct.

8. The offgas system hood of claim 7, wherein the at least one downflow duct further comprises a corresponding plurality of downflow duct sections.

9. The offgas system hood of claim 8, wherein each of the plurality of downflow duct sections are configured to receive at least one chain for rotating therein.

10. The offgas system hood of claim 7, wherein the chain terminates with an accretion-removal member configured for removal of accretions from the interior surface of the downflow duct.

11. The offgas system hood of claim 7, wherein the accretion-removal member is configured to either:
rotate within the interior surface of the downflow duct just short of touching the interior surface of the downflow duct; or
contact the inner surface of the downflow duct depending on the rotation speed of the at least one centrally rotating shaft.

12. The offgas system hood of claim 7, wherein the accretion-removal member is one or more distal chain links of each of the plurality of chains.

13. The offgas system hood of claim 7, wherein the accretion-removal member is a brush comprising metal bristles.

14. A method of management of offgas accretions in a smelting reducing vessel coupled to a hood, the method comprising:
providing at least one downflow duct operably coupled to the hood, the at least one downflow duct comprising:
an interior surface;
at least one centrally rotating shaft positioned within the at least one downflow duct; and
at least one chain proximally connected along each of the at least one centrally rotating shaft and distally extend therefrom;
an accretion-removal member connected to a distal end of the at least one chain;
rotating the at least one centrally rotating shaft at a rotation speed and causing the chain to rise vertically proportional to the rotation speed within the at least one downflow duct; and
removing at least some offgas accretions from the downflow duct.

15. The method of claim 14, further comprising improving heat transfer from the downflow duct.

16. The method of claim 14, wherein the accretion-removal member is one or more distal chain links of each of the at least one chain.

17. The method of claim 14, wherein the accretion-removal member is a brush comprising metal bristles.

18. The method of claim 14, wherein the accretion-removal member is fabricated from a material that is of lower durometer than an interior surface of the downflow duct, and of a melting temperature, chemical stability, and strength in a temperature range 500-1000° C. capable of removing the offgas accretions.

19. A direct smelting process comprising:
a smelt reduction vessel (SRV) configured for containing a bath of molten metal and slag;
an offgas system comprising at least one downflow duct, the at least one downflow ducts are each equipped with a centrally rotating shaft and a series of connected chains extending distally therefrom configured to rotate within an interior surface of the downflow ducts;
injecting carbonaceous material and final smelting of metalliferous ore into the SRV producing carbon-containing hot metal, molten slag, and CO-containing offgas,
injecting oxygen-containing gas into a topspace above the molten slag;
at least partially combusting the CO-containing offgas;
removing at least some accretions from the walls of the at least one downflow duct with the series of connected chains connected to a rotating shaft positioned in the downflow duct; and
providing enhancement of wall heat transfer and SRV process heat.

20. The direct smelting process of claim 19, wherein the smelt reduction vessel is coupled to a cyclone converter furnace (CCF).

21. The direct smelting process of claim 19, wherein the series of connected chains each comprise an accretion-removal member.

22. The method of claim 19, wherein the accretion-removal member is one or more distal chain links of each of the series of connected chains.

23. The method of claim 19, wherein the accretion-removal member is a brush comprising metal bristles.
